(19) United States
(12) Patent Application Publication
(10) Pub. No.: US 2012/0055094 A1
(43) Pub. Date: Mar. 8, 2012

(54) Frameless Multi-Layer Window Panel with Adhesive Bonded Edges

(75) Inventors: Donald Paul Iacovoni, Plymouth, MI (US); Paul L. Heirtzler, Northville, MI (US); Daniel J. Ondrus, Northville, MI (US)

(73) Assignee: FORD GLOBAL TECHNOLOGIES, LLC, Dearborn, MI (US)

(21) Appl. No.: 12/877,529

(22) Filed: Sep. 8, 2010

(51) Int. Cl. E05F 11/00; B32B 17/10; E06B 7/16; B32B 17/06

(52) U.S. Cl. 49/324; 428/426; 156/305

(57) ABSTRACT

A multi-layer, laminated panel for a frameless window assembly has an adhesive bead extending along a frameless edge of the panel to contacting and structurally bond the two outer layers of the pane, thereby increasing the stiffness of the panel. The panel is used in a movable window assembly for an automotive vehicle in which a regulator is mounted to the vehicle adjacent a window opening, a seal is installed in the window opening, and the panel is moved by the regulator to a closed position wherein the frameless edge of the panel engages the seal.

### BACKGROUND

1. Technical Field

Embodiments of the present invention relate to frameless window panels, such as are used in moveable window assemblies installed in automotive vehicles.

2. Background Art

Laminated glass panels are commonly used in automotive vehicle windows for a number of reasons, such as improved dampening of noise, vibration, and harshness (NVH). Laminated glass panels typically consist of two glass outer panels with a sheet of polymer material sandwiched therebetween.

One generally acknowledged drawback of using laminated glass panels for moveable window applications is a decrease in strength and stiffness of the glass panel as compared to a non-laminated, solid glass panel. This decreased stiffness is due to the poor shear characteristics of the polymer central layer and the related structural decoupling of the polymer layer with the adjoining glass layers. Thus, the laminated glass panel has lower structural efficiency than a solid glass panel with equal thickness.

This lower stiffness may result in an increased likelihood of panel blow-out at higher vehicle speeds and/or in high wind conditions. Panel blowout is the term used to describe the condition where a low dynamic pressure outside the vehicle, caused by the slipstream and/or wind, forces the window panel outward in the window seals enough to form a small gap and result in undesirable wind noise.

The reduced strength of a laminated glass panel can also lead to a greater likelihood of glass breakage while handling the glass prior to installation and during high stress situations during vehicle use. Such situations may include the slamming of a door containing the window, high aerodynamic pressures, or contact with other objects. Breakage is of particular concern when the window panel is used in a frameless glass system and so is provided with little or no support around its periphery from a structural window frame.

### SUMMARY

In a first disclosed embodiment, a laminated panel for a frameless window assembly comprises first and second outer layers, at least one inner layer sandwiched between the first and second outer layers, and an adhesive bead extending along at least a portion of a frameless edge of the panel and contacting and structurally bonding at least the two outer layers of the panel.

In another disclosed embodiment, a movable window assembly for an automotive vehicle comprises a regulator for mounting to the vehicle adjacent a window opening, a seal for installation in the window opening, and a window panel movable by the regulator to a closed position wherein a frameless edge of the panel engages the seal. The panel comprises first and second outer layers, at least one inner layer sandwiched between the first and second outer layers, and an adhesive bead extending along at least a portion of the frameless edge to contact and structurally bond at least the two outer layers of the panel.

In another disclosed embodiment, a method of forming a frameless laminate window panel comprises forming a multi-ply panel having first and second outer layers and at least one inner layer sandwiched therebetween, and applying a bead of adhesive along at least a portion of a frameless edge of the panel to contact and structurally bond together at least the first and second outer layers.

### BRIEF DESCRIPTION OF THE DRAWINGS

Embodiments of the present invention described herein are recited with particularity in the appended claims. However, other features will become more apparent, and the embodiments may be best understood by referring to the following detailed description in conjunction with the accompanying drawings, in which:

FIG. 1 is a schematic view of an automotive vehicle having a moveable, frameless window assembly in an entry door;

FIG. 2 is a schematic view of the car door and frameless window assembly of FIG. 1;

FIG. 3 is a partial cross-sectional view of an edge portion of a laminated window panel;

FIG. 4a is a schematic view of a window panel with a continuous adhesive bead extending along top and bottom edges;

FIG. 4b is a schematic view of a window panel with a continuous adhesive bead extending along front and rear edges; and

FIG. 4c is a schematic view of a window panel with a non-continuous adhesive bead extending along top and bottom edges.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

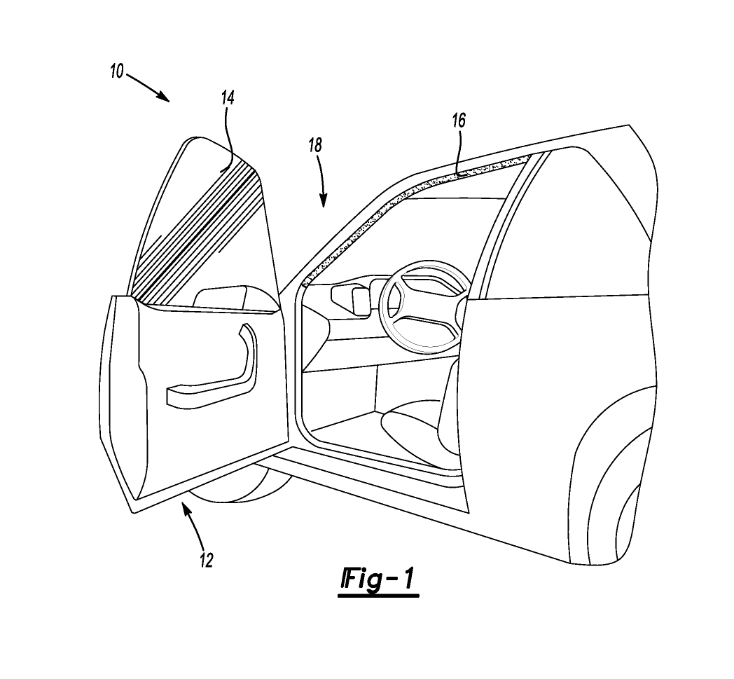

Referring to FIG. 1, an automotive vehicle 10 includes an entry door 12 that is hinged relative to the vehicle body so as to open in the conventionally known manner. Door 12 includes a frameless window panel 14 that engages a peripheral seal 16 extending around a periphery of a window opening 18 when the door is in the closed position (not shown).

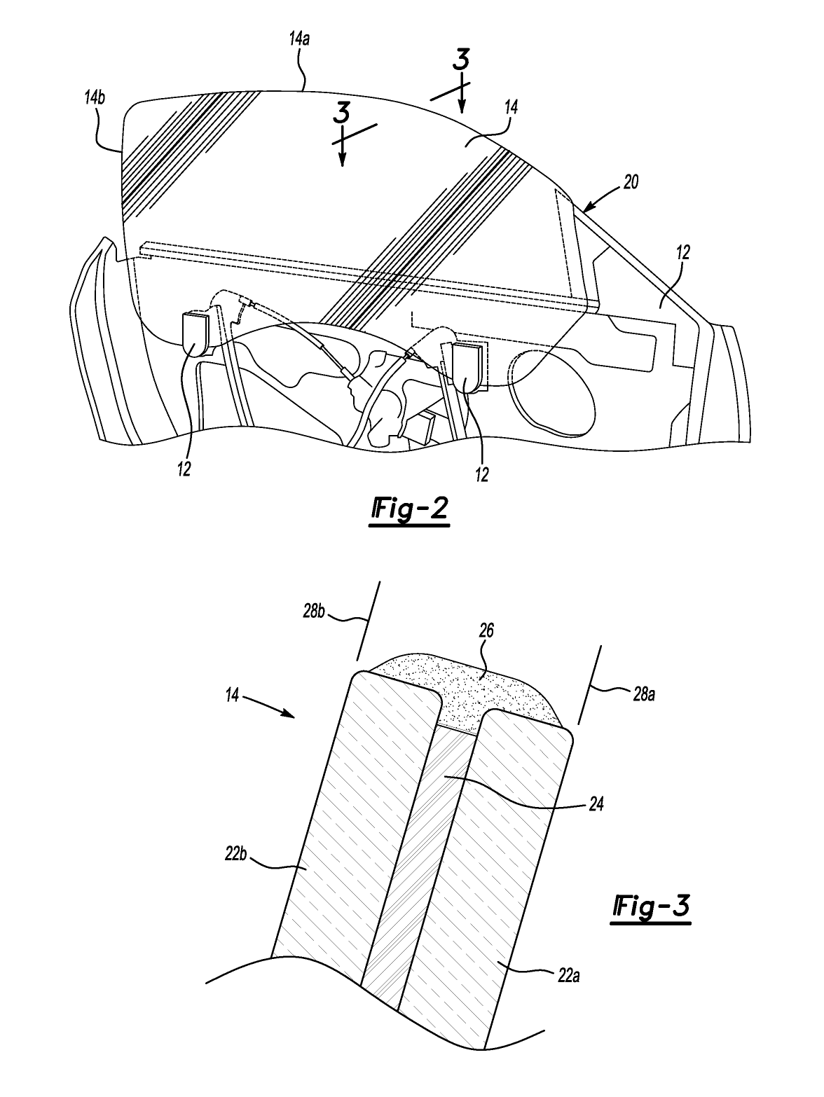

Referring now to FIG. 2, a moveable window assembly 20 is shown to include the frameless panel 14 and an electrically powered regulator 22 which engages the window panel adjacent its lower edge and is operable, as is well known in the art, to move the panel upwardly and downwardly upon actuation of a switch (not shown).

The term “frameless” as applied to the present window panel 14 indicates that the upper edge 14a and rear edge 14b are unsupported by any mechanical framing when the door 12 is in the open position. When window panel 14 is in the fully up position and door 12 is latched in the closed position relative to vehicle 20, the upper, forward, and rear peripheral edges of the panel engage seal 16 to provide an air-and-water-tight vehicle body structure. In a frameless window system construction, the perimeter edges of laminated panel 14 are unsupported by any frame or guide rails along all or most of the forward, rear, and upper edges. This is contrast with a framed window assembly in which forward and rear edges of the window are supported by guide rails throughout all or most of their range of vertical motion, and the upper edge is supported by an upper frame when the window is fully up/closed even when the door is open.

In FIG. 3, panel 14 is shown to comprise first and second outer layers of glass 22a, 22b and an inner layer 24 of a plastic material such as polyvinyl of butyral. As is well known in the automotive glass field, the inner plastic layer 24 provides sound deadening and impact-resistance. An adhesive bead 26 extends along at least a portion of the peripheral edge of panel 14 and structurally bonds the layers of the panel together so that the resulting laminate construction exhibits greater stiffness than is the case without the adhesive bead 26. Adhesive 26 is shown to contacts all three layers 22a, 22b, 24 of the panel, but significant strengthening of the panel may be achieved if the bead only contacts and bonds the two outer layers to one another.

Adhesive bead 26 preferably does not extend beyond boundaries 28a, 28b defined by opposite outermost surfaces of the two outer layers.

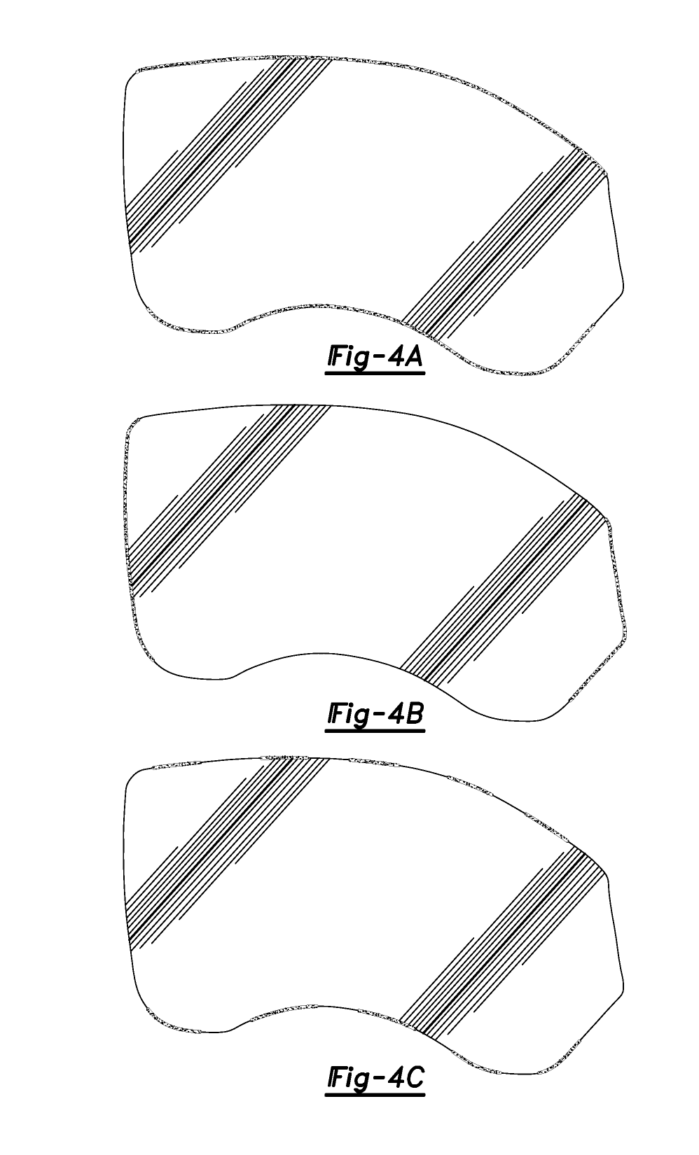

To achieve maximum panel stiffness, it may be desired to apply the adhesive bead around the entire peripheral edge of the panel. Depending upon various features of the particular application (geometry of the panel and door installation, etc.), though, it may not be necessary for the adhesive bead to extend around the entire peripheral edge of the panel in order to provide adequate stiffness. FIGS. 4a-c show several examples of window panels with less than the entire periphery. In FIG. 4a, a window panel has a continuous adhesive bead (schematically indicated by cross-hatching) extending along top and bottom edges. In FIG. 4b, a window panel has a continuous adhesive bead extending along the opposite front and rear edges. In FIG. 4c, a window panel has an intermittent (non-continuous) adhesive bead extending along the top and bottom edges. The exact configuration (placement, length, and spacing) of the segments of an intermittent bead required to achieve design goals may be determined by engineering analysis, simulation, and/or experimentation.

The adhesive material used for bead 26 may a one-component, ultraviolet cure, transparent, non-yellowing acrylic. Other types of adhesive may also be used, such as urethane (two-component or moisture cure), or a two-component epoxy-based formula.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed:

1. A laminated panel for a frameless window assembly comprising:
first and second outer layers;
an inner layer sandwiched between the first and second outer layers; and
an adhesive bead extending along a frameless edge of the panel and contacting and structurally bonding the two outer layers of the pane.

2. The panel according to claim 1 wherein the adhesive bead remains within boundaries defined by outermost surfaces of the two outer layers.

3. The panel according to claim 1 wherein the adhesive bead extends along at least two opposite portions of the frameless edge.

4. The assembly according to claim 1 wherein the adhesive bead extends along the entire frameless edge.

5. The panel according to claim 1 wherein the first and second outer layers are glass.

6. The panel according to claim 1 wherein the inner layer is polyvinyl butyral.

7. The panel according to claim 1 wherein the adhesive bead is acrylic.

8. A movable window assembly for an automotive vehicle comprising:
a regulator for mounting to the vehicle adjacent a window opening;
a seal for installation in the window opening; and
a panel movable by the regulator to a closed position wherein a frameless edge of the panel engages the seal and comprising:
first and second outer layers;
an inner layer sandwiched between the first and second outer layers; and
an adhesive bead extending along the frameless edge to contact and structurally bond the two outer layers of the panel.

9. The assembly according to claim 8 wherein the adhesive bead remains within boundaries defined by opposite outermost surfaces of the two outer layers.

10. The assembly according to claim 8 wherein the adhesive bead extends along at least two opposite portions of the frameless edge.

11. The assembly according to claim 8 wherein the adhesive bead extends along the entire frameless edge.

12. The assembly according to claim 8 wherein the first and second outer layers are glass.

13. The assembly according to claim 8 wherein the inner layer is polyvinyl butyral.

14. The assembly according to claim 8 wherein the adhesive bead is acrylic.

15. A method of forming a frameless laminate window panel comprising:
forming a multi-ply panel having first and second outer layers and an inner layer sandwiched therebetween; and
applying a bead of adhesive along a frameless edge of the panel to contact and structurally bond together the first and second outer layers.

16. The method according to claim 15 wherein the bead is applied along at least two opposite portions of the frameless edge.

17. The method according to claim 15 wherein the bead is applied along the entire frameless edge.

18. The method according to claim 15 wherein the bead is applied so as to remain within boundaries defined by opposite outermost surfaces of the two outer layers.

19. The method according to claim 15 wherein the inner layer is polyvinyl butyral.

20. The method according to claim 15 wherein the adhesive bead is acrylic.
